(19) United States
(12) Patent Application Publication
(10) Pub. No.: US 2012/0236599 A1
(43) Pub. Date: Sep. 20, 2012

(54) ELECTRONIC DEVICE

(76) Inventors: Tsuyoshi Maeda, Osaka (JP); Hidefumi Yoshida, Osaka (JP)

(21) Appl. No.: 13/514,245

(22) PCT Filed: Sep. 2, 2010
(86) PCT No.: PCT/JP2010/065047

§ 371 Date: Jun. 6, 2012

(30) Foreign Application Priority Data
Dec. 17, 2009 (JP) 2009-286691

(51) Int. Cl. F21V 8/00

(52) U.S. Cl. 362/621

(57) ABSTRACT

Provided is an electronic device including a small-area solar power generation system which is capable of efficiently generating power. A mobile device (10) includes: an optical module (2); and a storage section (1), the optical module (2) including: a light guide section which has a light receiving surface for receiving light from outside and guides the light thus received; and a solar cell element which is provided on an end face of the light guide section, the end face intersecting the light receiving surface, and receives the light thus guided through the light guide section, and the storage section (1) storing the optical module (2) so that the optical module can be drawn out from the storage section.

### TECHNICAL FIELD

The present invention relates to an electronic device, and particularly to an electronic device including a solar power generation system.

### BACKGROUND ART

In order to efficiently use solar energy, a conventionally used common solar power generation device collects sunlight by spreading solar panels over its surface so that the solar panels face the sun. A recently developed mobile device is exemplified by a mobile phone provided with such a solar power generation device.

Patent Literature 1 describes a technology of removably packaging, in a case of an electronic device, an IC card including a solar battery, and causing a lens provided so as to protrude from the case to collect sunlight in the solar battery. According to the electronic device described in Patent Literature 1, it is possible to generate solar power in the case by taking in light from an outside of the case to an inside of the case. Patent Literature 2 describes a video camera which is mounted with a plate over which solar panels are foldably spread. According to the video camera, the solar panels can be spread only during solar power generation, whereas the solar panels can be compactly folded when they are not used for power generation. Patent Literature 3 describes a solar cell array formed by spreading solar panels over a stretchable accordion-like sheet. According to the solar cell array, the solar panels can be spread by stretching the accordion-like sheet only during power generation, whereas the accordion-like sheet can be compactly contracted when it is not used for power generation.

### CITATION LIST

### Patent Literatures

Patent Literature 1
Japanese Patent Application Publication, Tokukaihei, No. 2-93993 A (Publication Date: Apr. 4, 1990)

Patent Literature 2
Japanese Patent Application Publication, Tokukaihei, No. 3-106271 A (Publication Date: May 2, 1991)

Patent Literature 3
Japanese Patent Application Publication, Tokukaihei, No. 4-146897 A (Publication Date: May 20, 1992)

### SUMMARY OF INVENTION

### Technical Problem

As described above, conventional solar panels to be used for solar power generation are commonly constituted by opaque semiconductors. This prevents the solar panels from being stacked. Therefore, in order to sufficiently collect sunlight, it is necessary to use large-area solar panels. The electronic device described in the Patent Literature 1 is limited in area since the solar battery is provided in the IC card. Further, light collection by use of a lens makes it impossible to desire a sufficient improvement in efficiency with which light collection is carried out. In contrast, according to the techniques described in the Patent Literatures 2 and 3, it is necessary to provide solar panels which are equivalent in area to the plate or the sheet which is spread for use in solar power generation.

The present invention has been made in view of the problems, and an object of the present invention is to provide an electronic device including a small-area solar power generation system which is capable of efficiently generating power.

### Solution to Problem

In order to attain the object, an electronic device in accordance with the present invention includes: an optical module; and a storage section, the optical module including: a light guide section which has a light receiving surface for receiving light from outside and guides the light thus received; and a solar cell element which is provided on an end face of the light guide section, the end face intersecting the light receiving surface, and receives the light thus guided through the light guide section, and the storage section storing the optical module so that the optical module can be drawn out from the storage section.

According to the configuration, it is possible to draw out the optical module from the storage section while the optical module is being used for power generation, and to store the optical module in the storage section when the optical module is not used for power generation. This prevents a power generation system from being exposed to an outside of the electronic device when the power generation system is not used. Therefore, it is possible to make a well-designed electronic device. Further, the electronic device in accordance with the present invention can efficiently collect sunlight in the solar cell element in accordance with an area of the light receiving surface of the optical module drawn out from the storage section. Therefore, it is only necessary to provide the solar cell element on the end face of the light guide section. This (i) makes it unnecessary to spread solar cell elements over the light receiving surface and (ii) allows a solar cell element having a small area to obtain a large amount of output.

### Advantageous Effects of Invention

An electronic device in accordance with the present invention includes: an optical module; and a storage section, the optical module including: a light guide section which has a light receiving surface for receiving light from outside and guides the light thus received; and a solar cell element which is provided on an end face of the light guide section, the end face intersecting the light receiving surface, and receives the light thus guided through the light guide section, and the storage section storing the optical module so that the optical module can be drawn out from the storage section. This (i) makes it unnecessary to spread solar cell elements over the light receiving surface and (ii) makes it possible to provide an electronic device including a small-area solar power generation system which is capable of efficiently generating power.

### BRIEF DESCRIPTION OF DRAWINGS

FIG. 1 is a view schematically showing a mobile device in accordance with an embodiment of the present invention.

FIG. 2 is a view describing an example of an optical module to be mounted in a mobile device in accordance with the present invention.

FIG. 3 is a view describing an example of an optical module to be mounted in the mobile device in accordance with the present invention.

FIG. 4 is a view describing an example of an optical module to be mounted in the mobile device in accordance with the present invention.

FIG. 5 is a view describing an example of an optical module to be mounted in the mobile device in accordance with the present invention.

### DESCRIPTION OF EMBODIMENTS

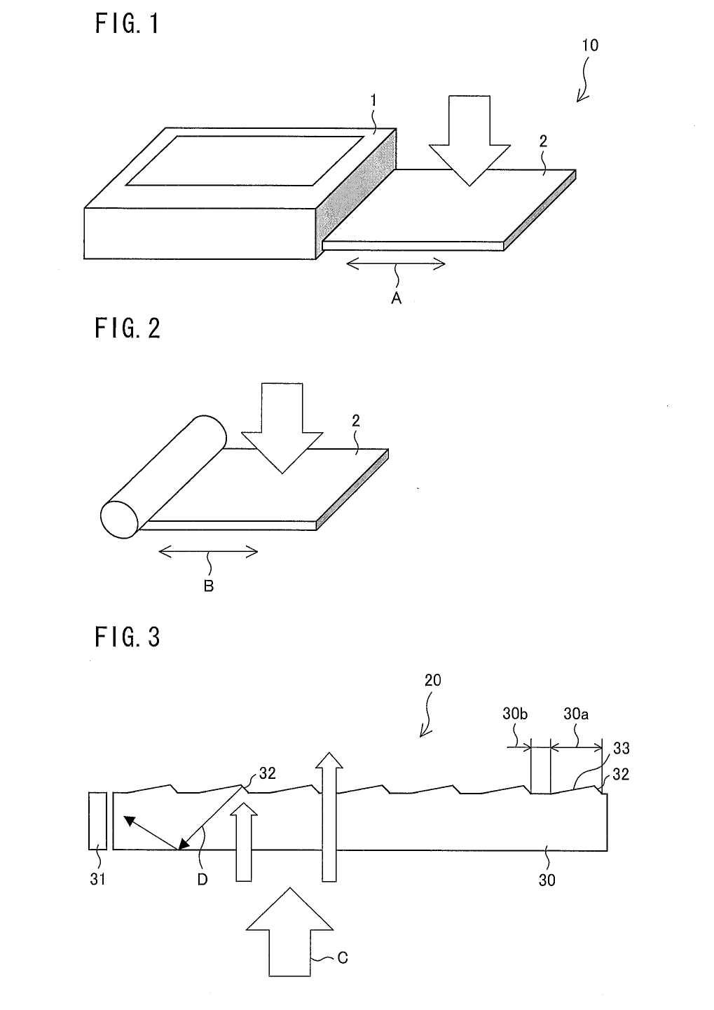

An embodiment of a mobile device (electronic device) 10 in accordance with the present invention is described below with reference to FIGS. 1 through 5. FIG. 1 is a view schematically showing the mobile device 10 in accordance with the embodiment of the present invention. FIGS. 2 through 5 are views describing examples of an optical module to be mounted in the mobile device 10. The mobile device 10 includes a storage section 1 and an optical module 2 (see FIG. 1). The optical module 2 includes: a light guide section which (i) has a light receiving surface for receiving light from outside, the light being emitted in an arrow direction which is perpendicular to the optical module and (ii) guides the light thus received; and a solar cell element which is provided on an end face of the light guide section, the end face intersecting the light receiving surface, and receives the light having been guided through the light guide section (see FIGS. 1 and 2).

[Mobile Device 10]

The mobile device 10 is directed to be a portable electronic device such as a mobile phone, a laptop computer, or a portable game machine. The mobile device 10 can be an electronic device driven by electric power generated in the optical module 2. The mobile device 10 may include a battery to accumulate an output from the optical module 2.

[Storage Section 1]

The storage section 1 stores the optical module 2 so that the optical module 2 can be drawn out from the storage section 1. The storage section 1, which has a shape that coincides with a shape of the mobile device 10, is configured to include a space in which the optical module 2 can be stored. The storage section 1 may be provided with a sliding mechanism which draws out the optical module 2 from the storage section 1 by causing the optical module 2 to slide. A conventional publicly-known mechanism can be used for such a sliding mechanism. The storage section 1 may be configured to include a storage space so that the optical module 2 can be completely stored in the storage section 1 when the optical module 2 is not used for power generation or charging.

It should be noted that according to the optical module 2, a location at which the solar cell element is provided is not particularly limited provided that the solar cell element is provided on the end face intersecting the light receiving surface of the light guide section. From the perspective of protection of the solar cell element, it is preferable that the solar cell element be provided so as to be stored in the storage section 1 also when the optical module 2 is drawn out.

[Optical Module 2]

The optical module 2 (i) guides light through the light guide section toward the solar cell element, the light having been received on the light receiving surface of the light guide section and (ii) causes the solar cell element which receives the light thus guided to generate power. The optical module 2 may be configured to slide in the storage section 1 in an arrow direction which is parallel to the storage section 1 (a direction of an arrow A in FIG. 1), so as to be drawn out from the storage section 1 and to be used for solar power generation.

In a case where the optical module 2 is configured as above, it is possible to use, as the optical module 2, an optical module obtained by providing a solar cell element on an end face of an optical plate formed by dispersing, in a light transmissive plate, a fluorescent material that diffuses incident light. In a case where the optical module 2 is an optical plate, it is preferable that the optical module 2 be large enough to be completely stored in the storage section 1. Alternatively, the optical module 2 may be configured to partially protrude from the storage section 1 so as to be easily drawn out.

Alternatively, the optical module 2 may be configured to be wound in the storage section 1 in an arrow direction which is parallel to the optical module 2 (a direction of an arrow B in FIG. 2), so as to be stored (see FIG. 2). Namely, the storage section 1 includes a conventional publicly-known winding mechanism, and the optical module 2 is stored in the storage section 1 by being wound on a shaft of the winding mechanism, and is drawn out from the storage section 1 by being unwound from the shaft so as to be used for solar power generation. In a case where the optical module 2 is configured as above, the optical module 2 can be a sheet-shaped optical sheet which can be wound on a shaft. Such an optical sheet can be formed by dispersing, in a light transmissive film, a fluorescent material that diffuses incident light.

The light transmissive plate which can be used for the optical module 2 is exemplified by a publicly-known plate such as an acrylic plate. The light transmissive film which can be used for the optical module 2 is exemplified by a publicly-known film such as a film made of acrylic resin. Examples of the fluorescent materials to be dispersed in such a plate or a film are rare-earth metal complexes. Examples of such rare-earth metal complexes include, but are not limited to, sialon fluorescent materials such as a [Tb(bpy)2]Cl3 metal complex, a [Tb(terpy)2]Cl3 metal complex, a [Eu(phen)2]Cl3 metal complex, and Ca-α-SiAlON:Eu. As the fluorescent materials, it is also possible to use (i) a hydrochloride or sulfate salt of a rare-earth metal such as samarium, terbium, europium, gadolinium, or dysprosium, (ii) a transition metal acid salt such as calcium molybdate or calcium tungstate, (iii) an aromatic hydrocarbon such as benzene and naphthalene, (iv) a phthalein pigment such as eosin and fluorescein, or (v) the like.

Note here that the mobile device 10 as shown in FIG. 1 was prepared and an amount of electric power generation thereof was examined. First, a plate (10 mm in thickness, 10 cm×10 cm in area) was prepared, the plate having been obtained by dispersing, in acrylic resin, approximately 5% by weight of a rare-earth metal complex (e.g., a [Tb(bpy)2]Cl3 metal complex, a [Tb(terpy)2]Cl3 metal complex, or a [Eu(phen)2]Cl3 metal complex) which emits light by sunlight and has a particle size in the range of 5 μm to 10 μm. The optical module 2 was configured by causing the acrylic plate thus prepared to be a light guide section and providing a solar cell on one of end faces of the light guide section, the solar cell having a light receiving section which is 10 mm in width. The optical module 2 thus configured was mounted in the mobile device 10, and was drawn out so as to be charged (see FIG. 1). In this case, the mobile device 10 generated electric power in an amount of approximately 1.5 W.

Next, the mobile device 10 in which the optical module 2 as shown in FIG. 2 was mounted was prepared, and an amount of electric power generation thereof was examined. First, a film (1 mm in thickness, 10 cm×10 cm in area) was prepared, the film having been obtained by dispersing, in PET resin, approximately 8% by weight of a phthalein pigment such as fluorescein which emits light by sunlight. The optical module was configured by causing the PET film thus prepared to be a light guide section and providing a solar cell on one of end faces of the light guide section, the solar cell having a light receiving section which is 2 mm in width. The optical module thus configured was mounted in the mobile device 10, and was drawn out so as to be charged (see FIG. 2). In this case, the mobile device 10 generated electric power in an amount of approximately 1.0 W.

As described above, the optical module 2 mounted in the mobile device 10 includes the light guide section and the solar cell element provided on the end face of the light guide section. This allows the solar cell element to efficiently collect sunlight in accordance with an area of the light receiving surface of the optical module 2 drawn out from the storage section 1. It is only necessary to provide the solar cell element on the end face of the light guide section. This (i) makes it unnecessary to spread solar cell elements over the light receiving surface and (ii) allows a solar cell element having a small area to obtain a large amount of output. Further, since the optical module 2 can be stored in the mobile device 10 when it is not charged, it is possible to make a well-designed electronic device.

Note here that another embodiment of a specific configuration of the light guide section and the solar cell element of the optical module 2 is to be described with reference to FIGS. 3 through 5. It should be noted that for convenience, the solar cell element is spaced from the end face of the light guide section in each of FIGS. 3 through 5. However, in the optical module 2, the solar cell element is provided so as to be in contact with the end face of the light guide section.

[Embodiment 1 of Optical Module]

An embodiment 1 of the optical module is described with reference to FIG. 3. As shown in FIG. 3, an optical module 20 includes a light guide section 30 and a solar cell element 31. The light guide section 30 has, on a back surface opposite a light incident surface (light receiving surface) on which light indicated by an arrow C is incident, (i) traveling direction changing parts 30a that change a direction of light from the light receiving surface and (ii) transmitting parts 30b that transmit the light from the light receiving surface.

For the solar cell element 31, a publicly-known solar cell can be used. Examples of the publicly-known solar cell include, but are not limited to, an amorphous silicon (a-Si) solar cell, a polycrystalline silicon solar cell, and a monocrystalline silicon solar cell. The solar cell element 31 is provided, by use of a conventional publicly-known transmissive adhesive or stopper, on an end face of the light guide section 30, the end face intersecting the light receiving surface of the light guide section 30. The solar cell element 31 is not particularly limited in size. However, it is preferable that the solar cell element 31 have a width which is equivalent to a thickness of the light guide section 30. This makes it possible to efficiently receive light which is guided through the light guide section 30 and then reaches a side surface of the light guide section 30. In addition, the number of solar cell elements 31 is not particularly limited, either.

Each of the traveling direction changing parts 30a has (i) a first inclined surface 32 that reflects the light from the light receiving surface and (ii) a second inclined surface 33 that is inclined towards a direction opposite to the first inclined surface. An angle between the second inclined surface 33 and the back surface is smaller than an angle between the first inclined surface 32 and the back surface. Further, the solar cell element 31 is provided on a surface of the light guide section 30, which surface is one of the surfaces intersecting the light receiving surface of the light guide section 30 and is closer to the second inclined surface 33 than to the first inclined surface 32.

The light guide section 30 is not limited provided that it (i) guides light having entered the light guide section 30 through the light receiving surface and (ii) causes the light to be collected in the solar cell element 31 provided on the end face of the light guide section 30. The light guide section 30 can be, for example, a conventional publicly-known board such as an acrylic board, a glass board, or a polycarbonate board.

The traveling direction changing parts 30a provided on the back surface of the light guide section 30 change a direction of the light having entered the light guide section 30 through the light receiving surface so that the light will be collected in the solar cell element 31 provided on the end face. The traveling direction changing parts 30a are provided so as to protrude out of the back surface of the light guide section 30. The traveling direction changing parts 30a may be constituted by arranging, on the back surface either in a striped pattern or in a random manner, a plurality of triangular prisms or triangular pyramids extending in a direction parallel to the end face of the light guide section 30. Alternatively, the traveling direction changing parts 30a may be prism-shaped protrusions having the same shape and constituted by (i) the respective first inclined surfaces 32 inclined towards the same direction and (ii) the respective second inclined surfaces 33 inclined towards the same direction. Furthermore, each of the traveling direction changing parts 30a may have an asymmetric cross section with an R-shaped tip when cut along a plane perpendicular to the back surface and to the end face.

The first inclined surface 32 of each of the traveling direction changing parts 30a is a reflective surface that reflects, preferably totally reflects, light having traveled from the light receiving surface and reached the first inclined surface 32, and is an inclined surface inclined with respect to the back surface. The light incident on and reflected by the first inclined surface 32 is guided through the light guide section 30 and collected in the solar cell element 31 (indicated by an arrow D in FIG. 3). The second inclined surface 33 is an inclined surface that is inclined at a smaller angle to the back surface than the first inclined surface 32 is. This makes it possible to guide the light reflected by the first inclined surface 32 through the light guide section 30 and collect the light to the solar cell element 31, while preventing the light from reaching and being scattered by the second inclined surface 33.

Specifically, an angle of inclination of the first inclined surface 32 is set so that the first inclined surface 32 can reflect the light having entered the light guide section 30 through the light receiving surface, and an angle of inclination of the second inclined surface 33 is set to be smaller than the angle of inclination of the first inclined surface 32 so that the light reflected by the first inclined surface 32 will not reach the second inclined surface 33. Accordingly, each of the traveling direction changing parts 30a has a triangular cross section when cut along the plane perpendicular to the back surface and to the end face, and has an asymmetric shape protruding out of the back surface.

The traveling direction changing parts 30a are made of the same material as the light guide section 30 and can be formed by cutting the back surface of the light guide section 30. Alternatively, the traveling direction changing parts 30a may be formed by (i) filling, with a material for the light guide section 30, a mold that can form the traveling direction changing parts 30a of a predetermined shape on the light guide section 30 and (ii) curing the material. The traveling direction changing parts 30a may be formed on the back surface of the light guide section 30 either in a form of protrusions or in a form of indentations.

The transmitting parts 30b provided on the back surface of the light guide section 30 (i) are configured to transmit the light having entered the light guide section 30 through the light receiving surface, (ii) are constituted by flat areas, and (iii) are areas of the back surface in which areas no traveling direction changing parts 30a are provided. In other words, the transmitting parts 30b and the back surface of the light guide section 30 share the same flat surface. Since the transmitting parts 30b transmit part of light having entered the light guide section 30, the light guide section 30 looks almost transparent when viewed from the back surface side.

As has been described, the optical module 20 has, on the back surface of the light guide section 30, the traveling direction changing parts 30a and the transmitting parts 30b. This makes it possible to efficiently (i) guide, through the light guide section 30, the light having entered the light guide section 30 through the light receiving surface and (ii) cause the light to be collected in the solar cell element 31, and thus possible to efficiently generate power. Since the solar cell element 31 is provided on a surface intersecting the light receiving surface of the light guide section 30, the optical module 20 is capable of achieving sufficient power generation efficiency despite its small area and being produced inexpensively.

Furthermore, the optical module 20 may be constituted by (i) preparing a light transmissive film (film) on which the traveling direction changing parts 30a and the transmitting parts 30b are formed and (ii) bonding, with a light transmissive adhesive, the light transmissive film to the light guide section 30. Note here that the optical module 20 is configured so that a refractive index n(a) of the adhesive and a refractive index n(s) of the light guide section 30 satisfy n(a) n(s), and, more preferably, satisfy n(a)<n(s). Further, it is also possible to configure the optical module 20 such that the n(s), the n(a), and a refractive index n(f) of the light transmissive film satisfy n(f)≦n(a)≦n(s). This suppresses reflection of light by the interface between the adhesive and the light transmissive film, which light has entered the light guide section 30 through the light incident surface and is reflected by the traveling direction changing parts 30a.

Furthermore, the optical module 20 may include a light transmissive board which is provided so as to face the back surface of the light guide section 30. This allows the light transmissive board to protect the traveling direction changing parts 30a and the transmitting parts 30b, so that a contact scratch, for example can be prevented. Further, the optical module 20 may include a plurality of light guide sections 30 stacked on top of each other so that the back surface of each light guide section 30 faces the light receiving surface of an adjacent light guide section 30. Note here that the solar cell element 31 is provided in a corresponding position of each of the light guide sections 30. This improves power generation efficiency of the optical module 20. In particular, with the arrangement in which the light guide sections 30 are stacked on top of each other so that the traveling direction changing parts 30a and the transmitting parts 30b of one light guide section 30 are out of alignment with those of other light guide sections 30, it is possible to achieve the following. That is, even if light having entered a first light guide section 30 through its light receiving surface traveled out through the back surface of the first light guide section 30, the light can be reflected by the back surface of a second or any subsequent light guide section 30 and be collected in a corresponding solar cell element 31.

Furthermore, the optical module 20 may have two light guide sections 30 which are stacked so that their respective back surfaces face each other. Such a configuration makes it possible to protect the traveling direction changing parts 30a and the transmitting parts 30b and to prevent a contact scratch, for example. The configuration also makes it possible to collect, in a corresponding solar cell element 31, light received by each of the two light guide sections 30 so that the light can be used for power generation. This allows light entering the optical module 20 from both sides of the optical module 20 to be used for power generation. Furthermore, the optical module 20 may have the traveling direction changing parts 30a and the transmitting parts 30b both on the light receiving surface and on the back surface of the light guide section 30. This allows light reflected by both the surfaces of the light guide section 30 to be collected in the solar cell element 31. This increases power generation efficiency of the solar cell element 31.

[Embodiment 2 of Optical Module]

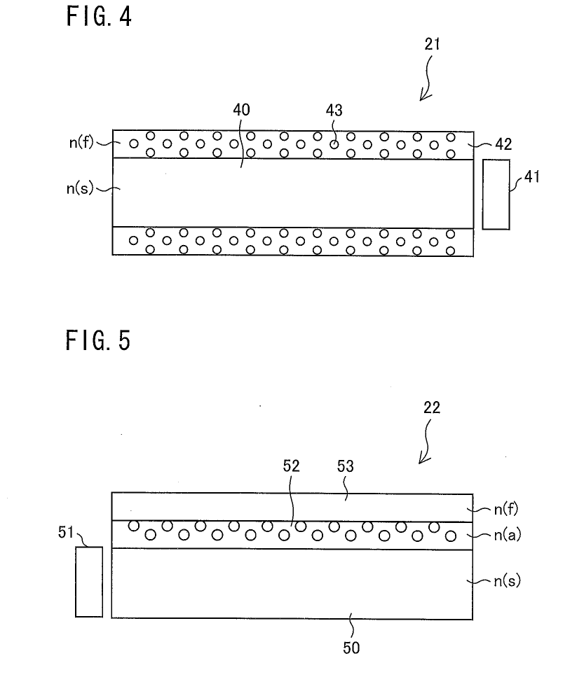

Embodiment 2 of the optical module is described with reference to FIG. 4. As shown in FIG. 4, an optical module 21 includes a light guide section 40, a solar cell element 41, and fluorescent material dispersion films 42 each containing a fluorescent material 43. One of the fluorescent material dispersion films 42 is bonded, via an adhesive, to a light receiving surface (front surface) of the light guide section 40, which light receiving surface receives sunlight. Likewise, the other of the fluorescent material dispersion films 42 is bonded, via an adhesive, to a surface opposite the light receiving surface of the light guide section 40. That is, the optical module 21 is configured such that the two fluorescent material dispersion films 42 sandwich the light guide section 40.

It should be noted that, although the fluorescent material dispersion films 42 may be bonded only to the light receiving surface, it is preferable to bond the fluorescent material dispersion films 42 to both the surfaces because bonding the fluorescent material dispersion films 42 to both the surfaces improves efficiency of power generation from sunlight. Further, the solar cell element 41 is provided on a surface (end face) intersecting the light receiving surface of the light guide section 40. A plurality of solar cell elements 41 may be provided on all of the four surfaces intersecting the light receiving surface. The solar cell element 41 can be made of a material of which the solar cell element 31 is made.

The light guide section 40 is not limited provided that it (i) diffuses light having entered the light guide section 40 through the light receiving surface and (ii) causes the light to be collected in the solar cell element 41 provided on the end face. The light guide section 40 can be, for example, a publicly-known board such as an acrylic board, a glass board, or a polycarbonate board. Since the light guide section 40 is provided for receiving light and guiding the light therethrough, the light guide section 40 is preferably a transparent plate containing no fluorescent materials. Note, however, that the light guide section 40 is not limited provided that it has been produced without dispersing therein a fluorescent material etc. in the production process so as to carry out wavelength conversion in the light guide section 40.

A fluorescent material dispersion film 42 is a film obtained by dispersing a fluorescent material in a light transmissive polymer material such as resin, which film is configured to convert the wavelength of light having entered the fluorescent material dispersion film 42 into a wavelength in a range effective for photoelectric conversion carried out by the solar cell element 41. As such a fluorescent material dispersion film 42, a publicly-known film can be used. The fluorescent material dispersion film 42 is for example, but is not limited to, a film obtained by dispersing the fluorescent material 43 in resin such as acrylic resin, polypropylene resin, cycloolefin resin, polycarbonate resin, triacetyl cellulose resin, or PET resin.

Examples of the fluorescent materials 43 to be dispersed in the fluorescent material dispersion film 42 are rare-earth metal complexes. Examples of such rare-earth metal complexes include, but are not limited to, sialon fluorescent materials such as a [Tb(bpy)2]Cl3 metal complex, a [Tb(terpy)2]Cl3 metal complex, a [Eu(phen)2]Cl3 metal complex, and Ca-α-SiAlON:Eu. As the fluorescent materials 43, it is also possible to use (i) a hydrochloride or sulfate salt of a rare-earth metal such as samarium, terbium, europium, gadolinium, or dysprosium, (ii) a transition metal acid salt such as calcium molybdate or calcium tungstate, (iii) an aromatic hydrocarbon such as benzene and naphthalene, (iv) a phthalein pigment such as eosin and fluorescein, or (v) the like.

It is preferable that the fluorescent material 43 have a particle size in the range of 5 μm to 10 μm. This makes it possible to achieve efficient fluorescence emission. Further, it is preferable that the content of the fluorescent material 43 in the fluorescent material dispersion film 42 be less than or equal to 10% by weight. This makes it possible to suppress multiple scattering and light absorption/extinction by the fluorescent material and thus possible to achieve efficient fluorescence emission.

The optical module 21 is configured such that a refractive index n(s) of the light guide section 40 and a refractive index n(f) of the fluorescent material dispersion film 42 satisfy n(f)≦n(s), and more preferably satisfy n(f)<n(s). This prevents light having entered the fluorescent material dispersion film 42 from being totally reflected by the interface between the fluorescent material dispersion film 42 and the light guide section 40, and therefore makes it possible to efficiently guide the light through the light guide section 40.

When light from a high refractive index region enters a low refractive index region, the light is totally reflected, depending on the angle of incidence. Using an example of the optical module 21, in the light guide section (an acrylic board) 40 having a refractive index of 1.5, light from the fluorescent material 43 will be emitted out of the light guide section 40 if the light is incident on a surface of the light guide section 40 at an angle of 0° to approximately 41° (assuming that the angle of line normal to the surface is 0°). On the other hand, the light incident at an angle equal to or more than approximately 41° is guided through the light guide section 40 and totally reflected repeatedly. In the case of using such an acrylic board having a refractive index of 1.5 as the light guide section 40, the ratio of the light guided through the light guide section 40 to the light emitted out of the light guide section 40 is approximately 75:25.

As described above, the optical module 21 makes it unnecessary to disperse a fluorescent material 43 in the light guide section 40, and uses the fluorescent material dispersion film 42 which can be inexpensively produced. This can achieve a reduction in production costs. Furthermore, since the solar cell element 41 is provided on the end face intersecting the light receiving surface of the light guide section 40, the optical module 21 can achieve sufficient power generation efficiency despite its small area and be inexpensively produced. In addition, since the relationship between the refractive index of the light guide section 40 and the refractive index of the fluorescent material dispersion film 42 is controlled, light from the fluorescent material 43 excited by sunlight can be efficiently guided through the light guide section 40.

Moreover, the optical module 21 may include a light transmissive adhesive layer between the light guide section 40 and the fluorescent material dispersion film 42 and cause the light transmissive adhesive layer to bond the light guide section 40 to the fluorescent material dispersion film 42. Note here that the optical module 21 is configured such that (i) a refractive index n(a) of the adhesive layer, and (ii) the n(s) and the n(f) satisfy n(f)≦n(a)≦n(s). This suppresses reflection at the interface due to the adhesive layer, and makes it possible to efficiently guide sunlight through the light guide section 40.

Further, in the optical module 21, the thickness, of the light guide section 40, in a direction intersecting a surface to which the fluorescent dispersion film 42 is bonded may be thicker in an end part than in a central part of the light guide section 40. That is, the light guide section 40 may be tapered from both end parts towards the central part. This makes it easy to attach the solar cell element 41.

In addition, the optical module 21 may be configured such that the fluorescent material dispersion films 42 contain a fluorescent material 43 whose maximum fluorescence wavelength is substantially equal to a maximum sensitivity wavelength of the solar cell element 41. This achieves efficient photoelectric conversion. Further, the fluorescent material dispersion films 42 may be constituted by a stack of films containing fluorescent materials 43 having respective different light absorption wavelengths. Note here that the fluorescent material dispersion films 42 is configured such that the plurality of films each contain a fluorescent material 43 having a maximum fluorescent wavelength substantially equal to a maximum sensitivity wavelength of the solar cell element 41. This makes it possible to convert light in various wavebands into light having a wavelength within the sensitivity range of the solar cell element 41, and thus possible to improve power generation efficiency.

Further, the optical module 21 may have the fluorescent material dispersion film 42 provided either over the entire light receiving surface of the light guide section 40 or on part of the light receiving surface. This (i) improves designability of the optical module 21 and (ii) reduces a chance that light guided through the light guide section 40 collides with the fluorescent material 43, thereby making it possible to efficiently guide the light and thus improving power generation efficiency.

It should be noted that, according to the optical module 21, the fluorescent material dispersion film 42 may be replaced with a fluorescent material layer formed by applying a light transmissive material containing a fluorescent material to a surface of the light guide section 40. In this case, the light transmissive material in which a fluorescent material is to be dispersed may be a high refractive index material, and the fluorescent material layer formed from the high refractive index material may be coated with a low refractive index material layer having a lower refractive index than that of the high refractive index material and serving as a protective layer.

[Embodiment 3 of Optical Module]

Embodiment 3 of the optical module is described with reference to FIG. 5. As shown in FIG. 5, an optical module 22 includes a light guide section 50, a solar cell element 51, an adhesive layer 52 containing a fluorescent material, and a light transmissive film 53. The light transmissive film 53 is bonded, via the adhesive layer 52, to a light receiving surface (front surface) of the light guide section 50 on which surface sunlight is incident. Further, another light transmissive film 53 may be bonded, via an adhesive layer 52, to a surface opposite the light receiving surface of the light guide section 50. The solar cell element 51 is provided on an end face of the light guide section 50, which end face intersects the light receiving surface. A plurality of solar cell elements 51 may be provided on all of the four end faces intersecting the light receiving surface. The solar cell element 51 can be made of a material of which the solar cell element 31 is made.

The adhesive layer 52 is a layer obtained by dispersing a fluorescent material in a light transmissive adhesive, which layer converts a wavelength of light having entered the adhesive layer 52 into a wavelength in a range effective for photoelectric conversion carried out in the solar cell element 51. The adhesive layer 52 can be obtained by dispersing a fluorescent material in a publicly-known light transmissive adhesive such as an acrylic adhesive etc., but is not limited to this. Other examples that can be suitably used as the adhesive layer 52 include adhesives each of which is obtained by dispersing a fluorescent material in an a-olefin adhesive, a urethane resin adhesive, an epoxy resin adhesive, an ethylene-polyvinyl acetate resin adhesive, a silicon adhesive, or the like.

Examples of the fluorescent materials to be dispersed in the adhesive layer 52 are rare-earth metal complexes. Examples of such rare-earth metal complexes include, but are not limited to, sialon fluorescent materials such as a [Tb(bpy)2]Cl3 metal complex, a [Tb(terpy)2]Cl3 metal complex, a [Eu(phen)2]Cl3 metal complex, and Ca-α-SiAlON:Eu. As the fluorescent materials, it is also possible to use (i) a hydrochloride or sulfate salt of a rare-earth metal such as samarium, terbium, europium, gadolinium, or dysprosium, (ii) a transition metal acid salt such as calcium molybdate or calcium tungstate, (iii) an aromatic hydrocarbon such as benzene and naphthalene, (iv) a phthalein pigment such as eosin and fluorescein, or (v) the like.

It is preferable that the fluorescent material dispersed in the adhesive layer 52 have a particle size in the range of 5 μm to 10 μm. This makes it possible to achieve efficient fluorescence emission. Further, it is preferable that the content of the fluorescent material in the adhesive layer 52 be less than or equal to 10% by weight. This makes it possible to suppress multiple scattering and light absorption/extinction by the fluorescent material and thus possible to achieve efficient fluorescence emission.

The light transmissive film 53 is not limited provided that it transmits incident light. Examples of a film that can be used as the light transmissive film 53 include a publicly-known light transmissive film such as a film made of acrylic resin, polypropylene resin, cycloolefin resin, polycarbonate resin, triacetyl cellulose resin, or PET resin.

The optical module 22 is configured such that a refractive index n(a) of the adhesive layer 52 and a refractive index n(s) of the light guide section 50 satisfy n(a)≦n(s), and, more preferably, satisfy n(a)<n(s). This prevents light having entered the optical module 22 from being totally reflected at the interface between the light guide section 50 and the adhesive layer 52, and thus makes it possible to efficiently guide the light through the light guide section 50.

Further, the optical module 22 can be configured such that the n(s), the n(a), and a refractive index n(f) of the light transmissive film 53 satisfy n(a)≦n(f), and n(a)≦n(s). This makes it possible to suppress reflection at the interface between the adhesive layer 52 and the light transmissive film 53, and thus possible to guide sunlight efficiently so that the light is collected in the solar cell element 51.

The optical module 22 uses, instead of a light guide plate in which a fluorescent material is dispersed, the adhesive layer 52 which can be inexpensively produced and in which a fluorescent material is dispersed. This allows a reduction in production costs. Further, since the fluorescent material is to be contained in the adhesive layer 52, it is easy to mix the fluorescent material and thus possible to easily form the adhesive layer 52 that can function as a fluorescent layer. Furthermore, since the solar cell element 51 is provided on the end face intersecting the light receiving surface of the light guide section 50, the optical module 22 can achieve sufficient power generation efficiency despite its small area and be inexpensively produced. In addition, since the relationship between the refractive index of the light guide section 50 and the refractive index of the adhesive layer 52 is controlled, light from the fluorescent material excited by sunlight can be efficiently guided through the light guide section 50.

Further, in the optical module 22, the thickness, of the light guide section 50, in a direction intersecting a surface to which the adhesive layer 52 is bonded may be thicker in an end part than in a central part of the light guide section 50. That is, the light guide section 50 may be tapered from both end parts towards the central part. This makes it easy to attach the solar cell element 51. Moreover, the optical module 22 may have a plurality of light guide sections 50, adjacent ones of which are bonded with the adhesive layer 52.

Further, the optical module 22 may be configured such that the adhesive layer 52 contains a fluorescent material whose maximum fluorescence wavelength is substantially equal to a maximum sensitivity wavelength of the solar cell element 51. This achieves efficient photoelectric conversion. Further, the adhesive layer 52 may be constituted by a stack of films containing fluorescent materials having respective different light absorption wavelengths. Note here that the adhesive layer 52 is configured such that the plurality of films each contain a fluorescent material having a maximum fluorescent wavelength substantially equal to a maximum sensitivity wavelength of the solar cell element 51. This makes it possible to convert light in various wavebands into light having a wavelength within the sensitivity range of the solar cell element 51, and thus possible to improve power generation efficiency.

Further, the optical module 22 may have the adhesive layer 52 provided either over the entire light receiving surface of the light guide section 50 or on part of the light receiving surface. This (i) improves designability of the optical module 22 and (ii) reduces a chance that light guided through the light guide section 50 collides with the fluorescent material, thereby making it possible to efficiently guide the light and thus improving power generation efficiency.

The present invention is not limited to the description of the embodiments above, but may be altered by a skilled person within the scope of the claims. An embodiment based on a proper combination of technical means disclosed in different embodiments is encompassed in the technical scope of the present invention.

It is preferable to configure an electronic device in accordance with the present invention such that the storage section includes a sliding mechanism which causes the optical module to slide in the storage section, so as to (i) store the optical module in the storage section and (ii) draw out the optical module from the storage section. This prevents a power generation system from being exposed to an outside of the electronic device when the power generation system is not used. Therefore, it is possible to make a well-designed electronic device.

It is preferable to configure an electronic device in accordance with the present invention such that the storage section includes a winding mechanism which (i) stores the optical module in the storage section by winding the optical module in the storage section and (ii) draws out the optical module from the storage section by unwinding the optical module from the storage section. This prevents a power generation system from being exposed to an outside of the electronic device when the power generation system is not used. Therefore, it is possible to make a well-designed electronic device.

Further, it is preferable to configure the electronic device in accordance with the present invention such that: the optical module includes: a light guide section; a fluorescent layer which is provided on at least one surface of the light guide section and contains a fluorescent material; and a solar cell element which is provided on a surface of the light guide section which surface intersects the at least one surface of the light guide section on which at least one the fluorescent layer is provided; and the fluorescent layer is constituted by a light transmissive film and an adhesive layer. In other words, it is preferable to configure the electronic device in accordance with the present invention such that: the optical module further includes a fluorescent layer which is provided on at least one surface of the light guide section and contains a fluorescent material; and the end face on which the solar cell element is provided is a surface that intersects the at least one surface of the light guide section on which at least one surface the fluorescent layer is provided. Furthermore, it is preferable to arrange the electronic device in accordance with the present invention such that the fluorescent layer causes either the light transmissive film or the adhesive layer to contain a fluorescent material.

According to the configuration, since the fluorescent material is dispersed in the light transmissive film or in the adhesive layer and the light transmissive film or the adhesive layer thus obtained is attached to the light guide section, it is (i) unnecessary to prepare a light guide plate in which a fluorescent material is dispersed and (ii) possible to freely pattern and/or stack the light transmissive film or the adhesive layer. Further, since the solar cell element is provided on a surface intersecting the light receiving surface of the light guide section, the optical module can achieve sufficient power generation efficiency despite its small area. As has been described, the configuration makes it possible to provide an optical module that can be highly freely designed and inexpensively and easily produced, while maintaining sufficient power generation efficiency.

It is preferable to configure the electronic device in accordance with the present invention such that: the optical module includes: the light guide section which further includes (i) a traveling direction changing part which changes a traveling direction of light having entered the light guide section through the light receiving surface and (ii) a transmitting part which transmits the light having entered the light guide section through the light receiving surface, the traveling direction changing part and the transmitting part each being provided on a back surface opposite the light receiving surface; and the solar cell element which is provided on an intersecting surface that intersects the light receiving surface of the light guide section; the traveling direction changing part has (i) a first inclined surface which reflects the light having entered the light guide section through the light receiving surface and (ii) a second inclined surface which is inclined with respect to the back surface at a smaller angle than the first inclined surface; and the solar cell element is provided on the intersecting surface which is located closer to the second inclined surface than to the first inclined surface.

According to the configuration, light incident on the traveling direction changing part from the light receiving surface is reflected by the first inclined surface and is collected in the solar cell element. This makes it possible to cause a larger amount of light that has entered the light guide section to be collected in the solar cell element, and thus possible to increase power generation efficiency. Hence, it is possible to make the optical module which is capable of efficiently generating power without the need of causing the light guide section to contain a fluorescent material. This makes it possible to inexpensively and easily produce the optical module.

### INDUSTRIAL APPLICABILITY

The present invention is applicable to a general portable electronic device.

### REFERENCE SIGNS LIST

1 Storage section
2 Optical module
10 Mobile device (electronic device)
20 Optical module
21 Optical module
22 Optical module
30 Light guide section
30a Traveling direction changing part
30b Transmitting part
31 Solar cell element
32 First inclined surface
33 Second inclined surface
40 Light guide section
41 Solar cell element
42 Fluorescent material dispersion film
43 Fluorescent material
50 Light guide section
51 Solar cell element
52 Adhesive layer
53 Light transmissive film

1. An electronic device comprising:
an optical module; and
a storage section,
the optical module including:
a light guide section which has a light receiving surface for receiving light from outside and guides the light thus received; and
a solar cell element which is provided on an end face of the light guide section, the end face intersecting the light receiving surface, and receives the light thus guided through the light guide section, and
the storage section storing the optical module so that the optical module can be drawn out from the storage section.

2. The electronic device as set forth in claim 1, wherein the storage section includes a sliding mechanism which causes the optical module to slide in the storage section, so as to (i) store the optical module in the storage section and (ii) draw out the optical module from the storage section.

3. The electronic device as set forth in claim 1, wherein the storage section includes a winding mechanism which (i) stores the optical module in the storage section by winding the optical module in the storage section and (ii) draws out the optical module from the storage section by unwinding the optical module from the storage section.

4. The electronic device as set forth in claim 1, wherein:
the optical module further includes a fluorescent layer which is provided on at least one surface of the light guide section and contains a fluorescent material; and
the end face on which the solar cell element is provided is a surface that intersects the at least one surface of the light guide section on which at least one surface the fluorescent layer is provided.

5. The electronic device as set forth in claim 4, wherein the fluorescent layer is a light transmissive film which is bonded to the at least one surface of the light guide section via an adhesive layer and contains a fluorescent material.

6. The electronic device as set forth in claim 4, wherein the fluorescent layer is an adhesive layer with which a light transmissive film is bonded to the at least one surface of the light guide section and which contains a fluorescent material.

7. The electronic device as set forth in claim 4, wherein the fluorescent layer is formed by applying, to the at least one surface of the light guide section, a light transmissive material which contains a fluorescent material.

8. The electronic device as set forth in claim 1, wherein:
the optical module includes:
the light guide section which further includes (i) a traveling direction changing part which changes a traveling direction of light having entered the light guide section through the light receiving surface and (ii) a transmitting part which transmits the light having entered the light guide section through the light receiving surface, the traveling direction changing part and the transmitting part each being provided on a back surface opposite the light receiving surface; and
the solar cell element which is provided on an intersecting surface that intersects the light receiving surface of the light guide section;
the traveling direction changing part has (i) a first inclined surface which reflects the light having entered the light guide section through the light receiving surface and (ii) a second inclined surface which is inclined with respect to the back surface at a smaller angle than the first inclined surface; and
the solar cell element is provided on the intersecting surface which is located closer to the second inclined surface than to the first inclined surface.
